(19) United States
(12) Patent Application Publication
(10) Pub. No.: US 2012/0203651 A1
(43) Pub. Date: Aug. 9, 2012

(54) METHOD AND SYSTEM FOR COLLABORATIVE OR CROWDSOURCED TAGGING OF IMAGES

(76) Inventor: Nathan Leggatt, Abbotsford (CA)

(21) Appl. No.: 13/359,123

(22) Filed: Jan. 26, 2012

Related U.S. Application Data
(60) Provisional application No. 61/439,829, filed on Feb. 4, 2011.

(51) Int. Cl. G06F 17/30; G06Q 30/08

(52) U.S. Cl. 705/26.3; 707/736; 707/E17.031

(57) ABSTRACT

A method for tagging images comprises embedding a code into a template file of a website, executing the code to activate the image by overlaying a tagging interface on the image, placing a tag within the image, and storing a copy of the tag in a database supported by a remote server. A unique random string of characters is generated as a function name before data is posted to the remote server and on response executes a string function to allow the tag to be displayed on the website and the copy of the tag be posted to the remote server while maintain system security.

### CROSS-REFERENCE TO RELATED APPLICATION

This application claims the benefit of provisional application 61/439,829 filed in the United States Patent and Trademark Office on Feb. 4, 2011, the disclosure of which is incorporated herein by reference and priority to which is claimed.

### BACKGROUND OF THE INVENTION

1. Field of the Invention

The present invention relates to a system and method for tagging images and other content and, in particular, to a method and system for collaborative or crowdsourced tagging of images.

2. Description of the Related Art

It is well known to tag images and other content on the Internet. This allows users to obtain additional information regarding products, persons and places shown in the images. Tagging may also be used by users to provide advertisements or point-of-sale bridges to prospective customers. For example, an image of a celebrity may be tagged to provide additional information regarding a jacket being worn by the celebrity. The additional information may include the brand and price of the jacket and even a link to the website of a manufacturer or retailer. This may lead to increased sales and profits and, at a minimum, provide users with valuable information about prospective customers based on an analysis of click-through rates. There are accordingly numerous methods and systems that have been developed for tagging images.

However, known methods and systems for tagging static images are limiting. Users are often required to upload static images to a server. The static image then is converted to a .swf file format or another suitable file format to allow the user to tag the image. Such systems and methods are limiting because they require that users change the file format of the static image and tag the static image within a third party administration console. Other systems and methods allow users to activate a website with a tag application but require that users tag static images via a third party backend administration area. Still other systems allow users to save a static image to a website, for example a social networking website such as FACEBOOK® or MYSPACE®, where the user can tag the static image but generally only via a backend administration area of the social networking website. The above described methods and systems for tagging static images do not allow users to tag static images from a front end of a website, i.e. where the static image is originally located. This limits the ability of collaborative or crowdsourced users to tag static images.

There is accordingly a need for an improved method and system for tagging static images and other content on the Internet to allow for collaborative or crowdsourced tagging.

### SUMMARY OF THE INVENTION

It is an object of the present invention to provide an improved method and system for tagging static images and other content.

There is accordingly provided an improved method and system for collaboratively tagging images which includes allowing a user to place a tag within an image on a webpage where the image is located. The method and system may further include rewarding the user for placing the tag.

A first embodiment of the method comprises embedding a code into a template file of a website, executing the code to activate the image by overlaying a tagging interface on the image, placing a tag within the image, and storing a copy of the tag in a database supported by a remote server. A unique random string of characters is generated as a function name before data is posted to the remote server and executes a string function which reduces the potential of an injected function to allow the tag to be displayed on the website and the copy of the tag be posted to the remote server while maintain system security. The method may further include determining a level of intrusiveness of the tagging interface. Placing a tag within the image in a first level of intrusiveness may include clicking an icon on the image. Placing the tag within the image in a second level of intrusiveness includes rolling a cursor over the image. Placing the tag within the image in a third level of intrusiveness includes hovering a cursor over a list of tags inside the image. Determining the level of intrusiveness of the tagging interface includes toggling the level of intrusiveness.

A second embodiment of the method comprises embedding a code into a template file of a website, executing the code to activate the image by overlaying a tagging interface on the image, providing a means to allow a first user to place a tag request on the image to request additional information on the image, and providing a means to allow a second user to place a tag within the image, and storing a copy of the tag in a database supported by a remote server. A unique random string of characters is generated as a function name before data is posted to the remote server and executes a string function which reduces the potential of an injected function to allow the tag to be displayed on the website and the copy of the tag be posted to the remote server while maintain system security.

A third embodiment of the method comprises embedding a code into a template file of a website, executing the code to activate the image by overlaying a tagging interface on the image, placing a tag within the image, and storing a copy of the tag in a database supported by a remote server. A unique random string of characters is generated as a function name before data is posted to the remote server and executes a string function which reduces the potential of an injected function to allow the tag to be displayed on the website and the copy of the tag be posted to the remote server while maintain system security. The method also includes providing a means for a first user and a second user to bid on the tag with the image, and linking the tag to a website of a highest bidder of the first user and the second user.

The means for the first user and the second user to bid on the tag may include allowing each of the first user and the second user to bid an amount to be paid for each click on the tag and bid a total amount to be paid. Linking the tag to the website of the highest bidder may include linking the tag to the website of the first user or the second user who bids a higher amount to be paid for each click on the tag until the total amount to be paid by said user is reached through pay-per-clicks. The method may further include paying a third user a royalty for placing the tag. The method may still further include paying a third user a royalty for placing the tag wherein the royalty is a percentage of a bid placed by the first user or the second user.

### BRIEF DESCRIPTIONS OF DRAWINGS

The invention will be more readily understood from the following description of the embodiments thereof given, by way of example only, with reference to the accompanying drawings, in which:

FIG. 1 is a schematic illustrating a distributed data processing system in which an improved method and system for tagging an image or other content may be implemented;

FIG. 2 is a schematic illustrating an exemplar architecture of a processor of the distributed data processing system of FIG. 1;

FIG. 3 is a schematic illustrating a routine for activating a website to allow images and other content found on the website to be tagged according to the improved method and system for tagging an image or other content disclosed herein;

FIGS. 4A and 4B are schematics illustrating an image on a website activated to level one intrusive of the improved method and system for tagging an image disclosed herein;

FIG. 5 is a schematic illustrating an image on a website activated to level two intrusive of the improved method and system for tagging an image disclosed herein;

FIGS. 6A and 6B are schematics illustrating images on a website activated to level three intrusive of the improved method and system for tagging an image disclosed herein;

FIG. 7 is a schematic illustrating a routine for tagging an image according to the improved method and system for tagging an image disclosed herein;

FIG. 8 is a schematic illustrating a routine for requesting a tag according to the improved method and system for tagging an image disclosed herein;

FIG. 9 is a schematic illustrating a routine for creating and responding to a tag request according to the improved method and system for tagging an image disclosed herein;

FIG. 10 is a schematic illustrating a routine for bidding on a tag according to the improved method and system for tagging an image disclosed herein;

FIG. 11 is a schematic illustrating how a user may search and access tags according to the improved method and system for tagging an image disclosed herein;

FIG. 12 is a schematic illustrating how a user may bookmark tags according to the improved method and system for tagging an image disclosed herein; and

FIGS. 13 to 20 are flowcharts illustrating the logic of one embodiment of an improved method and system for tagging an image disclosed herein.

### DESCRIPTIONS OF THE PREFERRED EMBODIMENTS

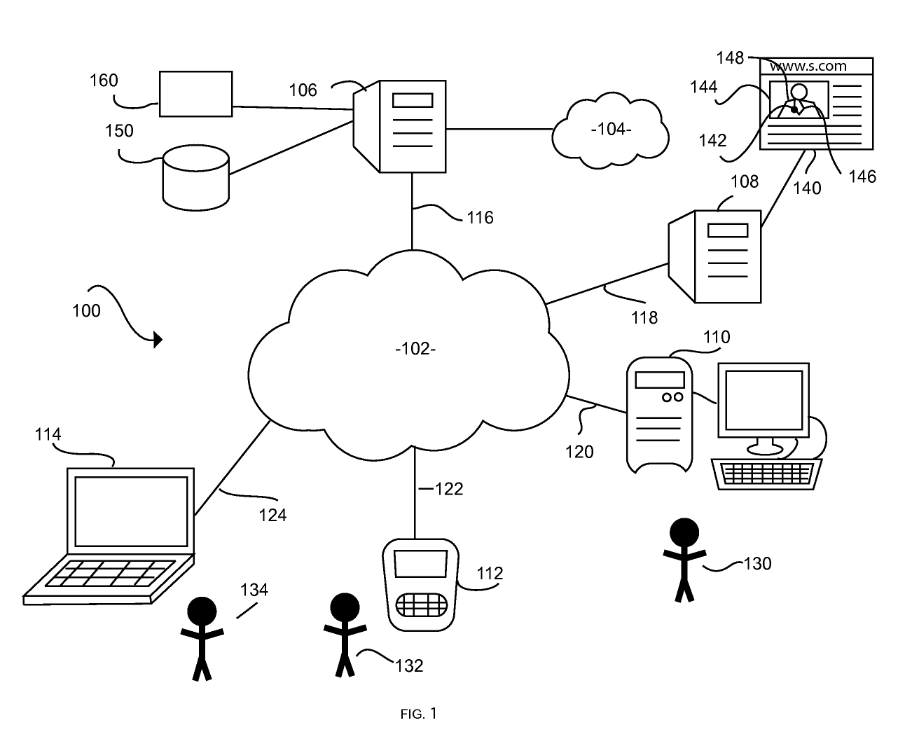

Referring to the drawings and first to FIG. 1, this shows a distributed data process system 100. The distributed data processing system 100 is given by way of example only and is typical of a distributed data processing system in which an improved method and system for tagging an image or other content may be implemented. The distributed data processing system 100 includes networks 102 and 104. In this example, network 102 is the Internet and network 104 is an intranet such as a wide area network (WAN) or local area network (LAN). The Internet, or network 102, allows for communication between various processors including two servers 106 and 108, a desktop computer 110, a handheld device 112 such as a personal digital assistant or smartphone, and a laptop computer 114. The intranet, or network 104, allows for communication between server 106 and other processors (not shown). It will be understood by a person skilled in the art that distributed data processing system 100 may further include additional processors and various types of processors which have not been shown.

The distributed data processing system 100 also includes various connections which provide communication links between the processors and the Internet, i.e. network 102. The communication links may be permanent connections including, but not limited to, wires 116 which connect server 106 to network 102 and fiber optic cables 118 which connect server 108 to the network 102. The communication links may also be temporary connections including, but not limited to, connections 120 made through a telephone which connect the desktop computer 114 to network 102 and wireless connections 122 and 124 which respectively connect the handheld device 112 and the laptop computer 124 to network 102.

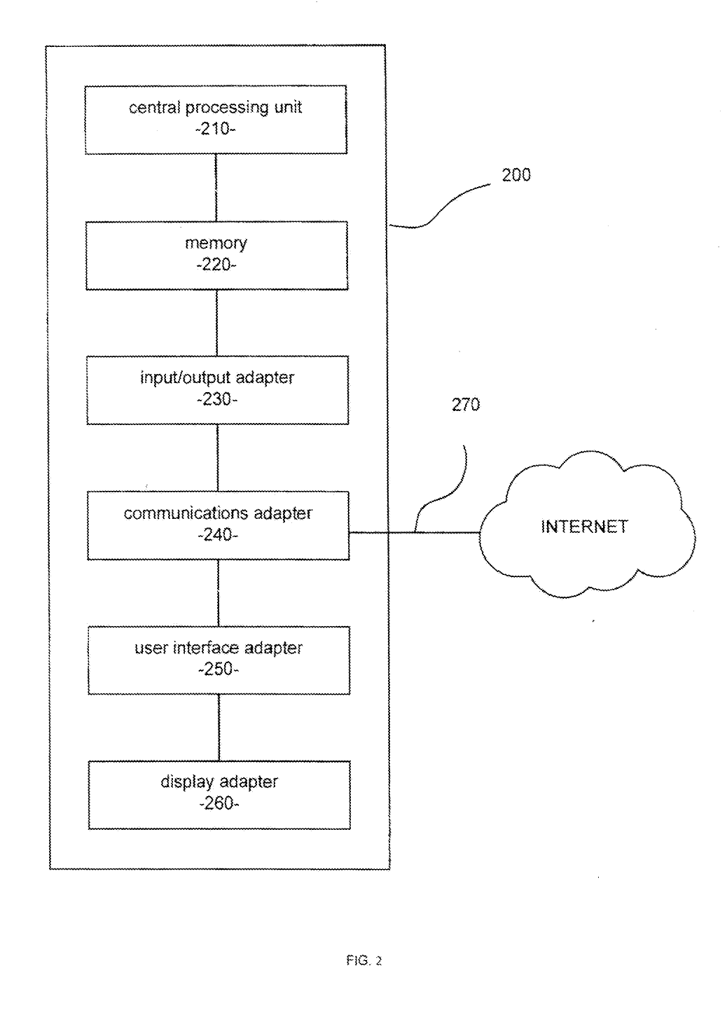

FIG. 2 shows an exemplar architecture of a processor in the distributed data processing system 100 of FIG. 1. An internal bus system 200 interconnects a central processing unit (CPU) 210 with a memory 220, an input/output adapter 230, a communications adapter 240, a user interface adapter 250, and a display adapter 260. The memory 220 may include one or more types of random access memory (RAM) and read only memory (ROM). The memory 220 may also include one or more types of volatile and non-volatile memory. The input/output adapter 230 may support various input/output devices, including but not limited to, a printer, a disk unit, and an audio unit. The communications adapter 240 may provide access to a communication link 270 such as a fiber optic cable which may connect the CPU 210 to the Internet. The user interface adapter 250 may support various user interface devices, including but not limited to, a touchscreen, a keyboard, and a mouse. The display adapter 260 may support various display devices such as a monitor. FIG. 2 is provided by way of example only and is in no way intended to imply architectural limitations to any processor in distributed data processing system 100 of FIG. 1. Furthermore, it will be understood by a person skilled in the art that the hardware of FIG. 2 may vary between processors.

In addition to being implemented on a variety of hardware platforms, the improved method and system for tagging an image or other content disclosed herein may be implemented on a variety of software platforms. Typically, an operating system is used to control program execution within a processor. However, the operating system used may vary between processors. For example, in the distributed data processing system 100 of FIG. 1, server 106 may run on a Linux® operating system, while server 108 runs on a Solaris® operating system and the desktop computer 110 runs on a Microsoft® operating system. Similarly, other processors in the distributed data processing system 100 may run on other operating systems. A processor in the distributed data processing system 100 may further support a typical browser application or another suitable application for retrieving HyperText Transfer Protocol (HTTP) documents in a variety formats.

In the distributed data system 100 of FIG. 1, users 130, 132 and 134 operate corresponding ones of the processors. In this example, user 130 is a website owner and operates the desktop computer 110. A website 140 owned by user 130 is hosted by server 108. User 132 is a customer and operates the handheld device 112 to search the Internet, i.e. network 102, for goods and services. User 134 is a crowdsourced tagger and operates the laptop computer 114 to search the Internet, i.e. network 102, for images and other content to tag. In FIG. 1, user 134 has placed a tag 142 on an image 144 located on the website 140 owned by user 130. The tag 142 includes information on a tie 146 being worn a person 148 in the image. If user 132 is interested in the tie 146 he or she may click on the tag 142 and obtain additional information on the tie 146. As thus far described the method and system for tagging images and other content is conventional.

However, tags placed by users according to the improved method and system disclosed herein differ from conventional tags in that additional product information is not displayed within a pop-up on tag rollover which acts a storefront with pricing and purchasing button. Conventional methods and systems for tagging typically do not allow users to create tags within an image on a website because of security concerns and restrictions built into browsers which do not allow cross-website scripting or execution of JavaScript® from a third party website. The improved method and system disclosed herein overcomes the above-mentioned concerns and restrictions, thereby allowing content to be displayed on a website and posted to a remote server while maintaining a high level of security.

Tags placed by users according to the improved method and system disclosed herein are created within the image being tagged as opposed to within an administration console of a third party tagging website. This is done by leveraging JavaScript® Object Notation with Padding (JSNOP) and JavaScript® methodologies to post and receive content from a server. To ensure the security of the system, a unique random string of characters is generated as a function name before data is posted to the server and on response executes the string function. This eliminates the potential of an injected function which could cause damage to the system and allows tags to be placed directly on an image. This also allows the tagging interface of the improved method and system to simply show a tag that when clicked takes the user to a linked website. In the example of FIG. 1, a copy of the tag 142 placed by user 134 on the image 144 found on the website 140 is also stored in a database 150 supported by server 106.

For user 134 to be able to place the tag 142 on the image 144 located on the website 140 owned by user 130 it is necessary for the website 140 to be activated. To activate the website 140 user 130 registers the website 140 with server 106 and a series of lines of code are embedded into the website template files (not shown in FIG. 1). In this example, the code is the JavaScript® code but any suitable code may be used. User 130 can then choose to activate specific static images on the website, activate all images within a specific DIV object, or activate images within the above criteria which are a certain dimension size, e.g. 250×250 pixels. There is an administration console 160 supported by server 106 from within which a user can customize and change the name of an image specific Cascading Style Sheet (CCS) class as well as an eXtensible HyperText Markup Language (XHTML) DIV object class name. The code embedded into the website template files produces software which overlays a tagging interface on images found on the website. The software does not use jQUERY™ or other JavaScript® libraries to overlay a tagging interface.

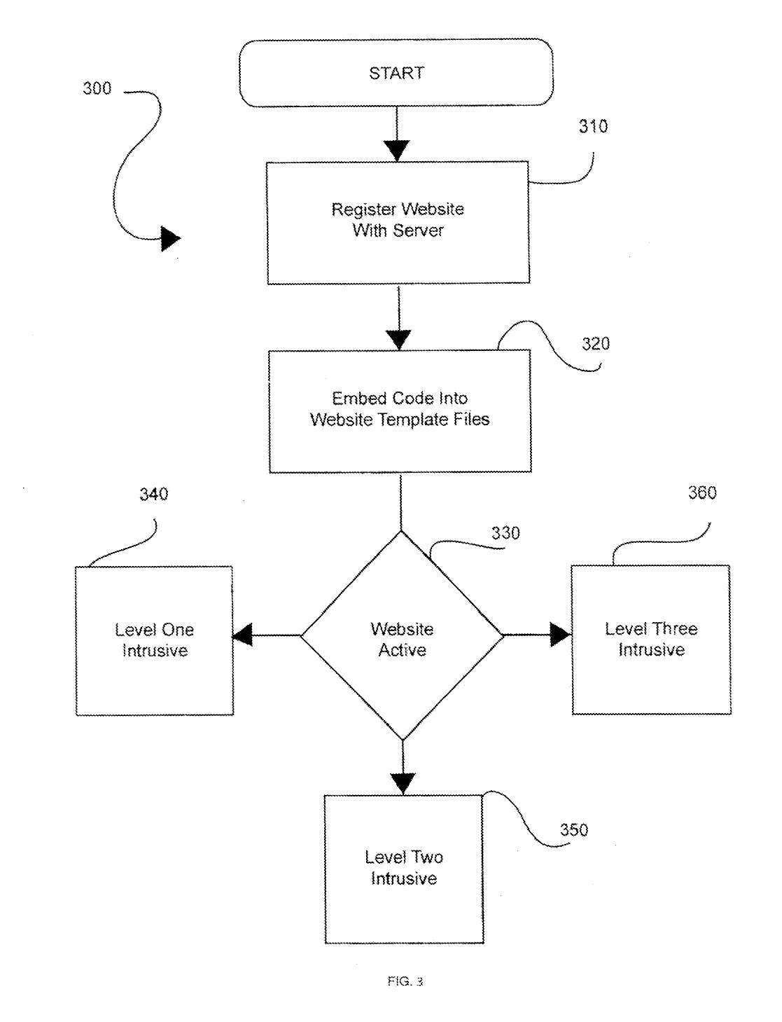

FIG. 3 shows a routine 300 for activating a website to allow tags to be placed on images and other content on the website. The website is registered at step 310 and code is embedded into the website template files at step 320. At step 330 a decision is made as to level of intrusiveness. In this example, the embedded code provides for three levels of intrusiveness of the tagging interface. Step 340 is level one intrusive in which an image is activated for tagging by clicking an icon on the image. Step 350 is level two intrusive in which an image is activated for tagging by rolling a cursor over the image. Step 360 is level three intrusive in which an image is active at all times and is provided with a footer which includes a list of tags placed on the image. In certain embodiments, the tags on the images are highlighted when a cursor is hovered over the corresponding listing.

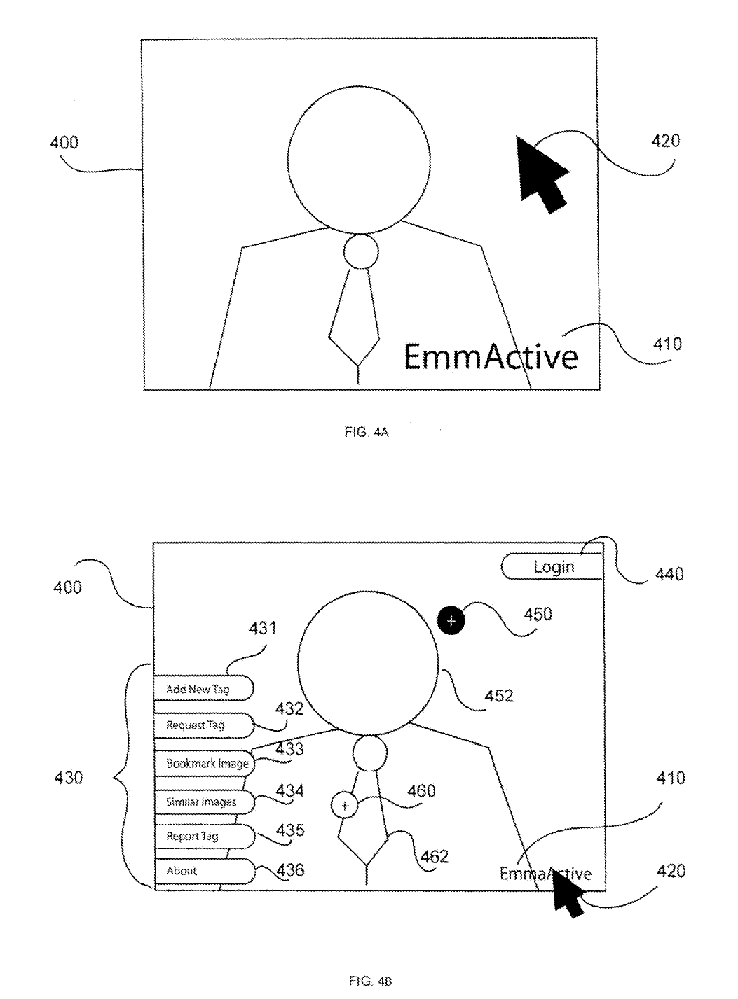

FIGS. 4A and 4B show an image 400 at level one intrusive. As shown in FIG. 4A an activating icon 410 which, in this example, is the logo EmmaActive disposed in a bottom right corner of the image 400. The image 400 otherwise appears conventional until, as shown in FIG. 4B, a cursor 420 is positioned over the icon 410 and the icon 410 is clicked to activate the image 400. This causes a tagging interface to overlay the image 400 within the website where the image is displayed. The tagging interface includes a menu 430 disposed on a left side of the image 400. In this example, the menu 430 includes the following tab selections Add New Tag 431, Request Tag 432, Bookmark Image 433, Similar Images 434, Report Tag 435, and About 436. However, in other examples, the menu 430 may include any desired number and combination of selections. The tagging interface further includes login icon 440 disposed in a top right corner of the image 400 and tags 450 and 460 placed on the image 400. In this example, tag 450 relates to a person 452 shown in the image 400 and tag 460 relates to a tie 462 being worn by the person 452.

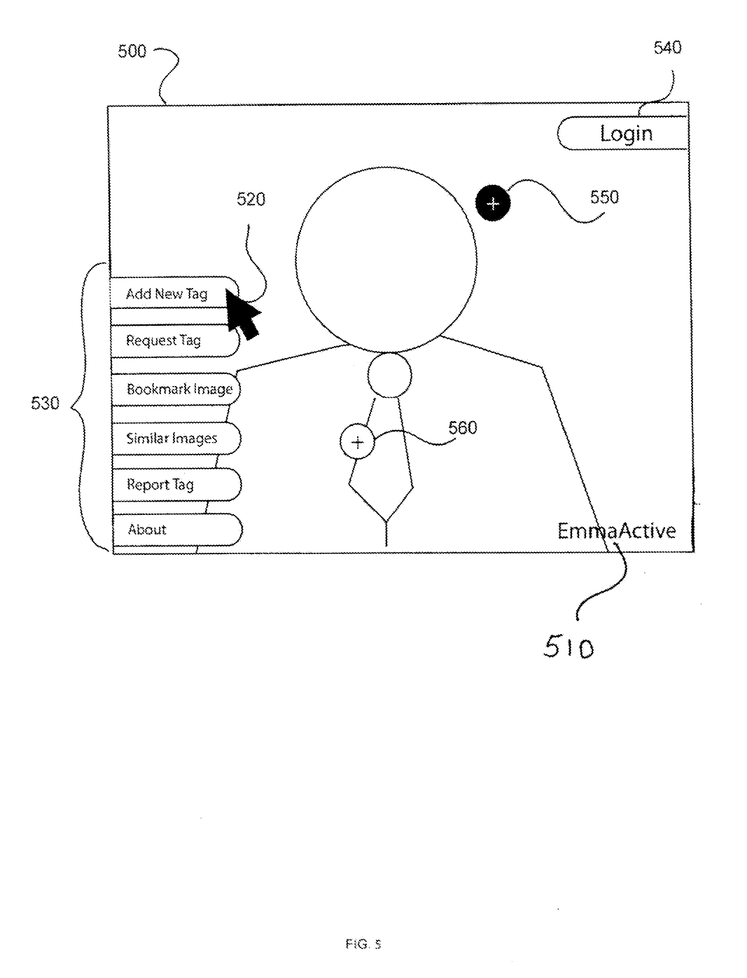

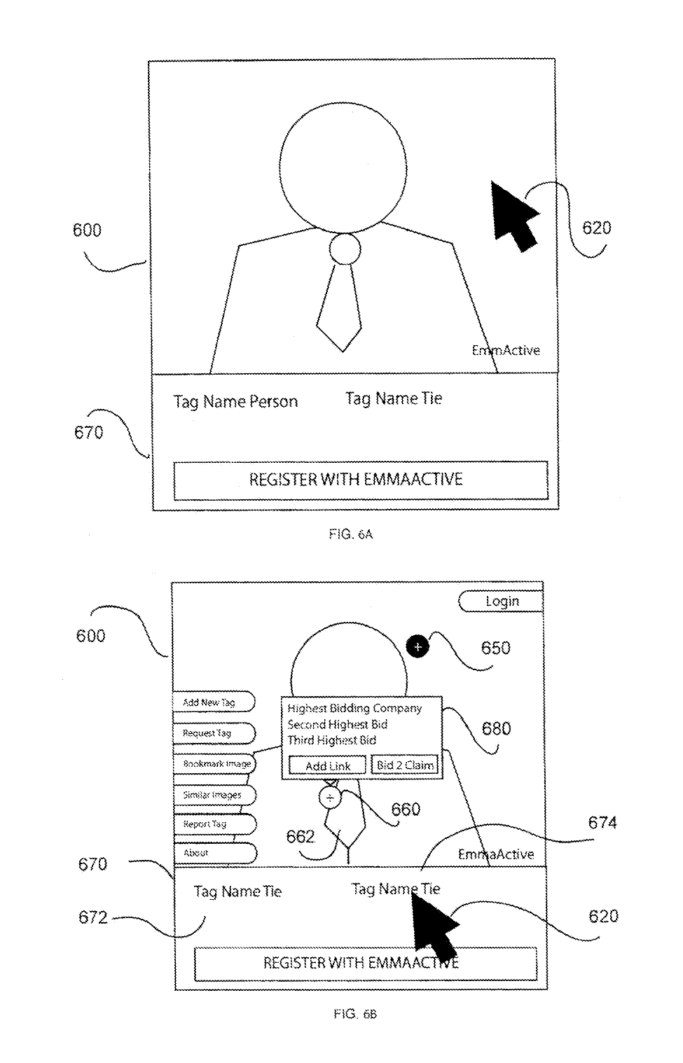

FIG. 5 shows an image 500 at level two intrusive. At level two intrusive an icon 510 may be disposed in the bottom right corner of the image 500 and the image 500 is activated by rolling a cursor 520 over the image 500. This causes a tagging interface to overlay the image. The tagging interface includes menu 530, login icon 540 and tags 550 and 560. FIGS. 6A and 6B show an image 600 at level three intrusive. At level three intrusive the image 600 is active at all times and there is a list of tags in a footer 670 inside the image 600. The footer 670 includes a list of the tags 650 and 660 placed on the image. In this example, the list includes list member 672 which corresponds to tag 650, and list member 674 which corresponds to member 660. When a cursor 620 is hovered over the list members 672 and 674 the corresponding one of the tags 650 and 660 on the image 600 highlight. For example, in FIG. 6B the cursor is hovered over list member 674 causing tag 660 to highlight and box 680 to appear over the image. Box 680 provides links to websites where a tie 662 tagged with tag 660 may be purchased. Box 680 also provides options for a user to add links or bid for links as will be described in greater detail below.

A user may toggle the level of intrusiveness of the tagging interface of a website to make it more or less obvious to other users that the website is activated. This is an advantage over conventional methods and systems for tagging images which typically only have a single level of intrusiveness.

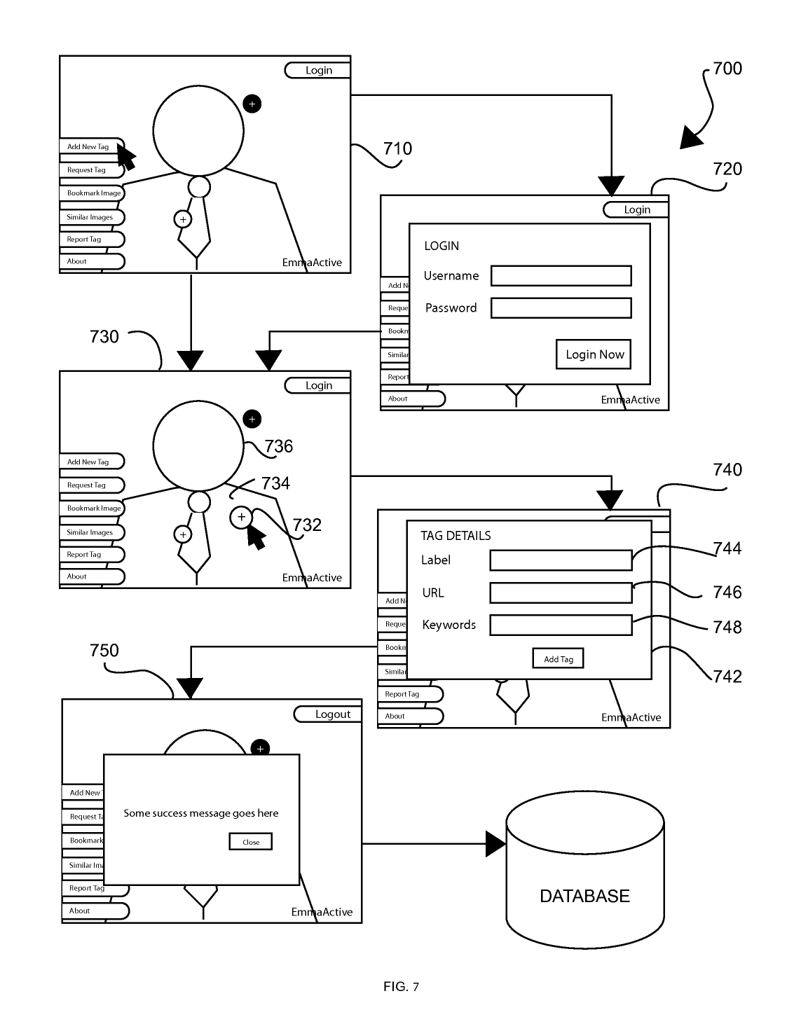

FIG. 7 shows a routine 700 for placing a tag on an image according to the improved method and system for tagging an image disclosed herein. At step 710 a user clicks on the Add New Tag tab of the tagging interface. If the user is not logged onto the tagging system the user will be prompted to login at step 720. If the user is already logged onto the system they can proceed directly to step 730 and add a tag by clicking on the image. In the example of FIG. 7, the user is placing a tag 732 on a shirt 734 worn by a person 736 in the image. When the user clicks on the shirt 732, and as shown at step 740, a box 742 appears overtop the image and allows the user to input information about the shirt, i.e. product information. The box 742 includes a plurality of input fields 744, 746 and 748. The input fields allow the user to enter desired product information which may include a tag label, a URL to a website where additional information on the shirt may be obtained or where the shirt may be purchased, and keywords which may later be used to bookmark or search the tag 732. After the user inputs the product information, the user clicks an ADD TAG button and the tag 732 is created as shown at step 750. The tag 732 is stored in a database and may later be bookmarked or searched.

Three different models may be leveraged to approve tags created by a user. In a first model no approval is required and tags created by users become active immediately. In a second model approval is required by the owner of the website on which the tag is placed before becoming active. This is done via an administration console. In a third model smart approval is utilized with tags placed by users having a tag trustworthy score above an upper threshold value becoming active immediately, tags placed by users having a tag trustworthy score between an upper threshold value and a lower threshold value requiring approval of the web site owner before becoming active, and tags placed by users having a tag trustworthy score below a lower threshold value not becoming active. The third model is designed to reduce the administration required by website owners who have a large number of images on their website.

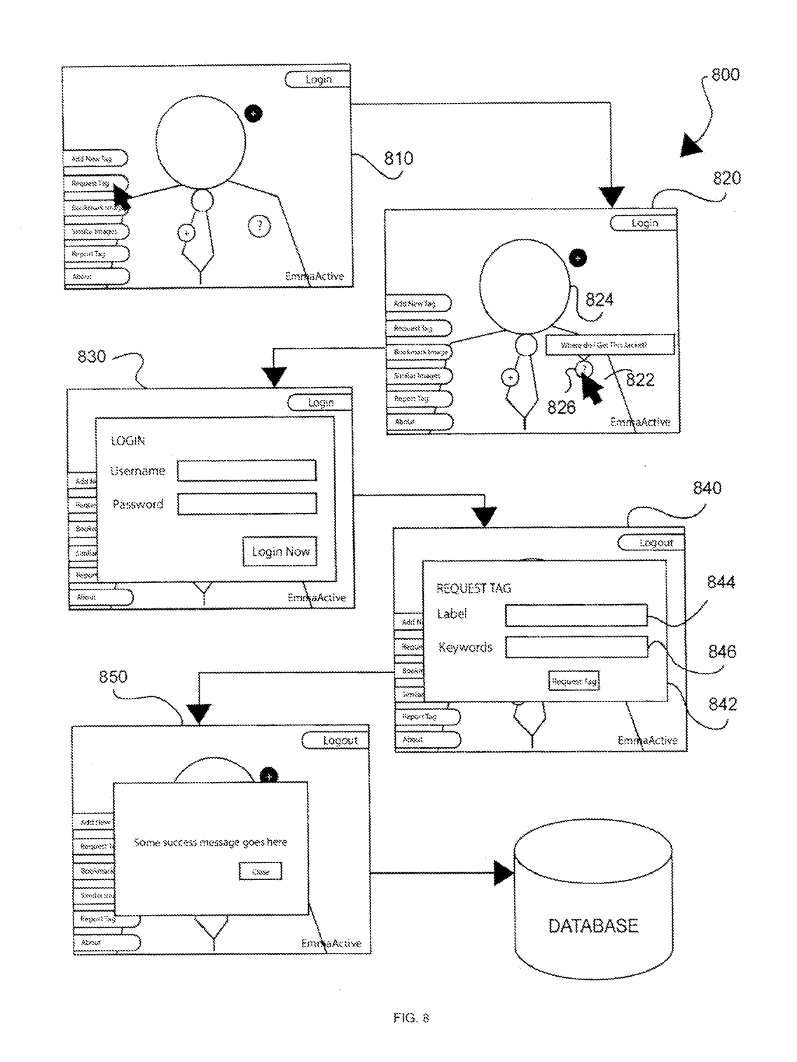

In addition to being able to create tags that provide additional product information a user is also able to request a tag that provides additional product information. FIG. 8 shows a routine 800 for requesting a tag according to the improved method and system for tagging an image disclosed herein. At step 810 a user clicks on the Request Tag tab of the tagging interface and at step 820 the user clicks on the product in the image for which the user desires additional product information. In the example of FIG. 8, the user desires additional product information about a shirt 822 worn by a person 824 in the image. If the user is not logged into the system the user will be prompted to login at step 830. If the user is already logged on to the system they can proceed directly to step 840 and request a tag by clicking on the image. Alternatively, the user may proceed directly to step 840 without logging in and request a tag as a guest. When the user clicks on the image, as shown as step 840, a box 842 appears overtop the image prompting the user to input requested information. The box 842 includes a plurality of input fields 844 and 846 which allow the user to request desired product information. At least one of the input fields 844 is for a tag request label and at least one of the input fields 846 is for keywords which may later be used to bookmark or search the tag request. After the user inputs the desired product information, the user clicks the REQUEST TAG button and the tag request is created as shown at step 850. The tag request is stored in a database and may later be searched by another user and, in particular, a business.

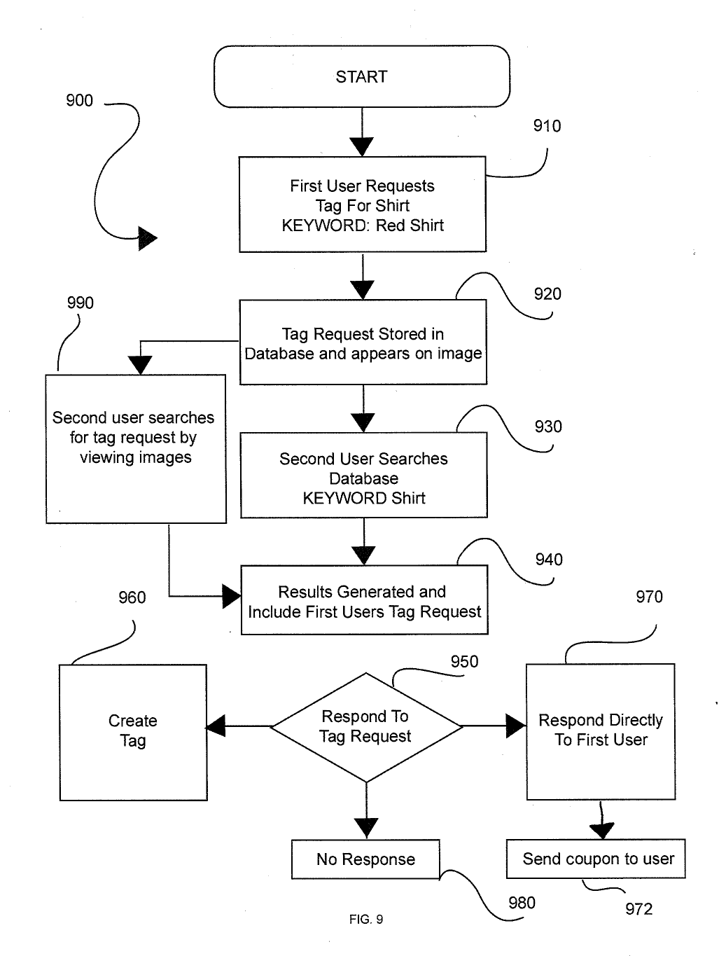

The tag request itself appears as a question mark 826 as shown at step 820. This alerts other users that a tag request has been placed. Accordingly, other users viewing the image may create a tag as shown in FIG. 7. Alternatively, other users may search the database in which a copy of the tag request is stored for tag requests related to products or services they offer. FIG. 9 shows a routine 900 for creating and responding to a tag request. At step 910 a first user, typically a website owner or crowdsourced tagger, creates a tag request requesting additional product information regarding a product, which in this example is a shirt. The first user inputs keywords such as “red shirt” when creating the tag request. The tag request is stored in a database at step 920. At step 930 a second user, typically a business, searches for tag requests in the database. The second user searches for tag requests associated with a keyword such as “shirt”. This generates a list of results that includes the tag request created by the first user. At step 950 the second user decides how to respond to the tag request. The second user may elect to either proceed with step 960 and create a tag, proceed with step 970 and respond directly to the user, or proceed with both steps 960 and 970. Alternatively, the second user may proceed to step 980 and not respond to the tag request. Tag requests may also be found manually by viewing images on the Internet as shown at step 990.

Allowing the second user, e,g. a business, to respond directly to the first user, e.g. a crowdsourced tagger or website owner, allows the business to develop brand loyalty by offering crowdsourced taggers and website owners incentives for requesting tags or placing tags with links to the businesses website. For example, when a crowdsourced tagger or website owner tagger requests a tag for a flat screen television a business may respond by sending a coupon or other reward to the crowdsourced tagger or website owner who placed the tag request. This is shown at step 972 of FIG. 9. Similarly, when a crowdsourced tagger places a tag on a flat screen television with a link to a website operated by the business, the business may automatically send a coupon to the crowdsourced tagger and may even send a coupon to the website owner. This not only creates brand loyalty for the business but also provides a highly valuable and redeemable offline return on investment.

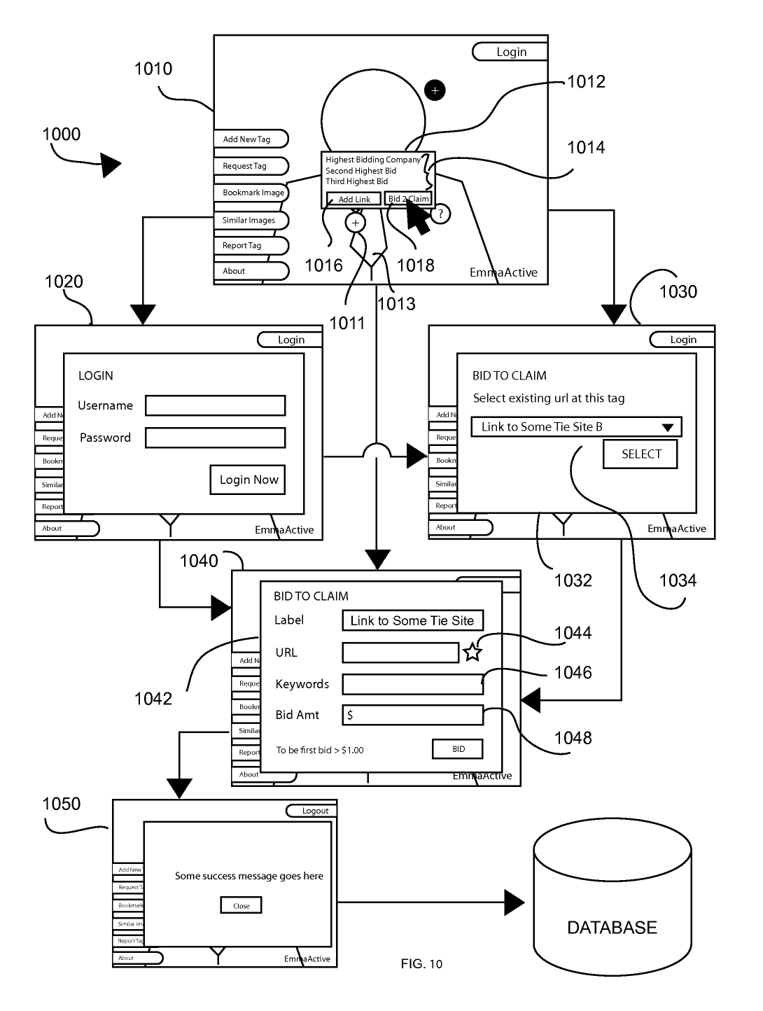

A user is also able to bid on existing tags. FIG. 10 shows a routine 1000 for a user, typically a business, to bid on an existing tag. At step 1010 the user clicks on a tag 1011 causing a box 1012 to appear over the image. The box 1012 includes a list of links to websites 1014 where additional information on the tagged product, a tie 1013 in this example, may be found or where the tagged product may be purchased. The websites are listed in descending order with the websites of the highest paying user being listed at the top. The box 1012 also includes an ADD LINK button 1016 and a BID TO CLAIM button 1018.

To add a link to the tag 1011 the user clicks on the ADD LINK button 1016. If the user is not logged into the tagging system the user will be prompted to login at step 1020. If the user is already logged onto the system the user can proceed directly to step 1040 and add a link. Links to both paying and non-paying websites may be added. However, if the user desires a preferential placement of their link they should bid on the tag 1011 to increase their chances of preferential placement.

To bid on the tag 1011 the user clicks on the BID TO CLAIM button 1018. If the user is not logged into the tagging system the user will be prompted to login at step 1020. If the user is already logged onto the system the user can proceed directly to step 1030 where a first BID TO CLAIM box 1032 appears over the image. The first BID TO CLAIM box 1032 includes a list of previously registered URLs 1034 that the user may select to be linked to the image by the tag. After the user has selected the desired URL, the user clicks the SELECT button and proceeds to step 1040 in which a second BID TO CLAIM box 1042 appears over the image. In cases where the user does not have any registered URLs the user will proceed directly to step 1040 and manually enter a URL into the second BID TO CLAIM box 1042. The second BID TO CLAIM box 1042 further includes a plurality of input fields 1044, 1046 and 1048. The input fields allow the user to enter a tag label, keywords to allow other users to search for the tag, and a bid amount. The user then clicks the BID button and the bid is processed at step 1050.

In one example, the user allocates a pay-per-click spending limit in the input field 1048 for the bid amount indicating how much they are willing to pay-per-click and/or spend in a given time period, typically a month. The bid amount is managed via a backend account area. The user's URL will then become listed on the list of links to websites 1014 until the spending limited is reached. It will be understood that pay-per-click may be paid at a varying cost based on the type of website being linked. For example, an incoming link to a sports website may be paid at a higher pay-per-click than an incoming link to a book website. It is foreseeable that two users may sell similar products such as the tie 1013 shown in FIG. 10. In this case, if a first user bids to pay $2.00-per-click and a second user bids to pay $1.00-per-click, the first user as the highest bidder gets its URL listed first and the second user, as the lower bidder, gets its URL listed second. Alternatively, the first user as the highest bidder may have its URL placed as a default link for the tag 1011 until the bid amount for the given time period is reached at which time the second user gets its URL placed as the default link. The system accordingly uses an auction based methodology to determine which link to display.

In addition to allowing users to bid on tags the system also allows other users such as crowdsourced taggers and website owners to place tags for other users such as users with registered paying websites. Once a user is registered as a paying website, the user's URLs are listed in a publically viewable directory and other users may place tags with links to the websites. The user placing the tag is paid a percentage of the pay-per-click bid amount for the linked website. If a tag is already placed and a user merely links the tag to the paying website of another user then a portion of the pay-per-click bid amount may be paid to the user who placed the tag, the user who linked the tag, the user who owns the website on which the tag is placed or any combination thereof. In the event that there are no paying websites for a particular product a user may still place a tag with a link to non-paying website. When a link to a non-paying website is clicked a transition advertisement for a similar product or content provider may be shown.

Five different variables may be used to determine what percentage of the pay-per-click bid amount to pay a user for placing a tag. These variables are (1) how many tags were created over a given period of time, e.g. twelve months, with a weight focus on more recent tags; (2) how many of the tags were reported as bad tags; (3) how many of the tags were linked to paying sites; (4) how many of the tags have been reported; and (5) how many times the user has been blocked from tagging on a website. Using these variables or other similar variables to determine what percentage of the pay-per-click bid amount to pay a user for placing a tag creates an incentive for users to properly place tags. Similar variables may also be used to calculate a tag trustworthy score to determine if tags placed by a user should even become active.

The system also provides a means for tracking images between websites. If a user saves a tagged image on a first website and the image is later uploaded onto a second website, the tagged image displayed on the second website will maintain the placed tags and associated links. This ensures that the user who placed the tags and/or the user who owns the first website are rewarded for the tags placed on the first website. It is foreseeable that a user who is a copyright owner may activate an image and place a number of tags on the image, then allow other websites to use the image without a royalty charge and instead mandate that the other websites are required to maintain the image activated within the system discloses herein to allow the user, who is a copyright owner, to generate revenues by collecting a percentage of the pay-per-click bid amount paid to a user for placing a tag.

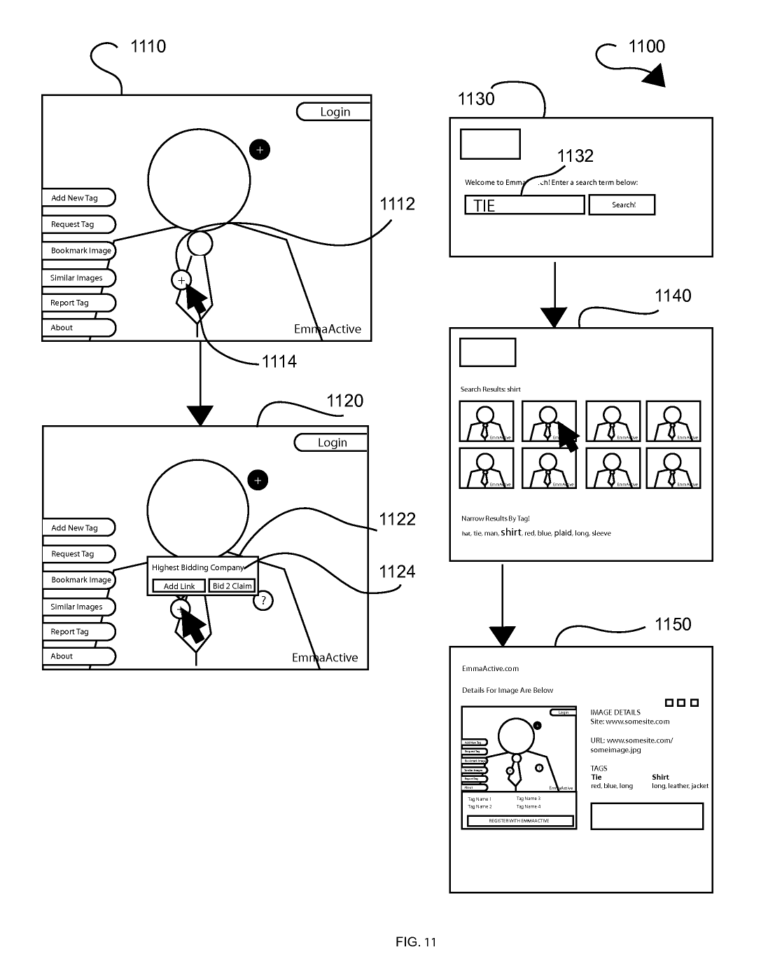

FIG. 11 shows a routine 1100 for accessing and searching tags. At step 1110 a user clicks on a tag 1112 associated with a tie 1114 shown in the image. This causes a box 1122 to appear over the image as shown at step 1120. The box 1122 includes a link 1124 to a website where the user may obtain additional product information on the tie 1114 or even purchase the tie. Any user may access the tag 1122 and the user does not have to be logged onto the system to access the tag 1122. To search for a tag, and as shown at step 1130, a user enters search parameters in the form of keywords into a search field 1132. After the user enters the keywords and clicks the SEARCH button, search results are displayed at step 1140. The search results include images with tags having tag names and tag keywords similar to the keywords being searched. Clicking on an individual result brings up detailed information on the selected image and tags placed thereon. This is shown at step 1150. The search returns highly accurate results because results are based on humanly provided tag names and tag keywords which are provided when the tags are placed. This differs from conventional systems in which search results are based on surrounding contextual information contained on the webpage where the image is located or meta information contained within the img src attributes.

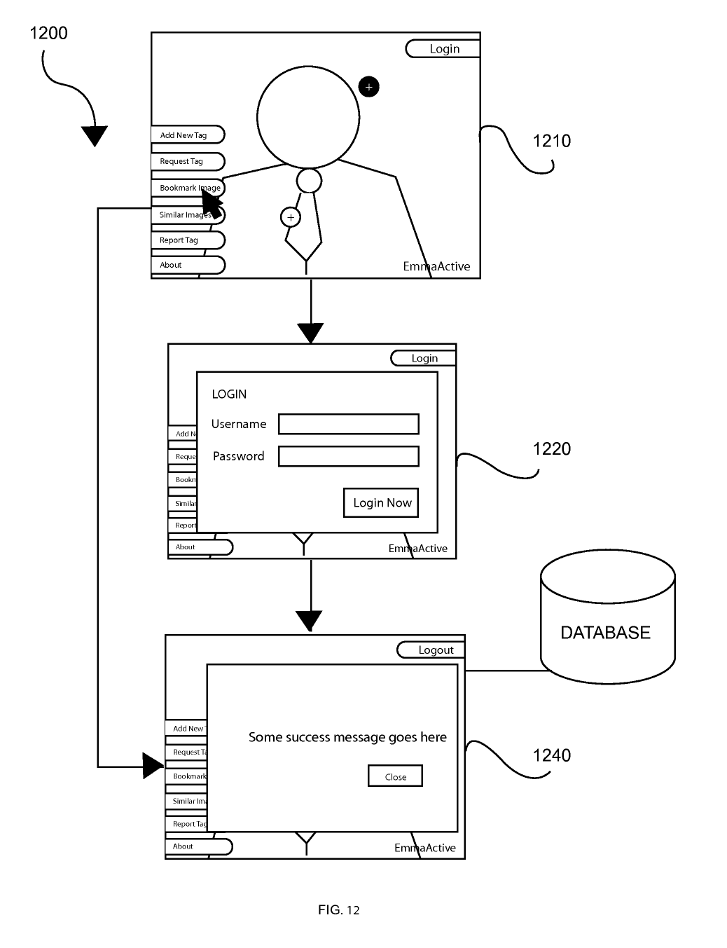

FIG. 12 shows a routine 1200 for bookmarking tags. At step 1210 a user clicks on the Bookmark Image tab of the tagging interface. If the user is not logged into the tagging system the user will be prompted to login at step 1220. The tag is then bookmarked at step 1240 and the bookmark is stored in a database within a tagger administration area. A user can accordingly bookmark a tagged image and later retrieve the image to show other users. The bookmarked tag may also be also be emailed to other users.

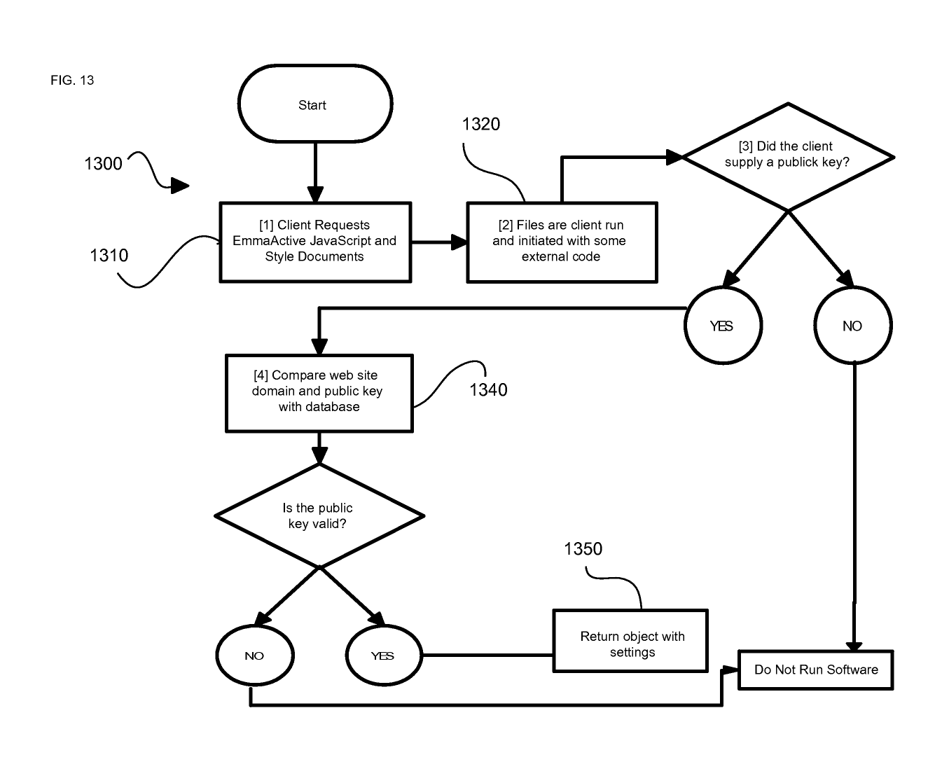

FIGS. 13 to 20 show the logic of an embodiment of the method and system for collaborative or crowdsourced tagging of images disclosed herein. FIG. 13 shows a routine 1300 in which, at step 1310, a user communicates with a server using JSONP™ to activate a website. This is accomplished by creating a temporary script tag in the document head that will contact a specified PHP URL of the website being activated. The server will do its business and return a JSONP™ value. When a value is returned the temporary script tag is destroyed and JavaScript® business is continued.

The user will request and load files from the server on page load of a website. This is accomplished with a script tag and CSS link tag in the document head provided by server after online registration. Below is an example of how this may look:

<head>
<link href=“http://static.emmaactive.com/emma.css”
rel=“stylesheet” type=“text/css” />
<script src=“http://static.emmaactive.com/emma.js”
type=“text/javascript”></script>
</head>

Once the requested files are loaded they can be run as shown at step 1320 with either one of the following routines:

### Routine A

A website public key may be attached onto the JavaScript® URL as shown below:

http://static.emmaactive.com/emma.js#b404d717-485e-407e-ae97-3462c27376a8
This will cause software used to tag images to auto run using default settings.

### Routine B

Alternatively, a CCS class may be initiated as follows:

<script type=“text/javascript”>
EmmaActive([

publicKey: “b404d717-485e-407e-ae97-3462c27376a8”,
intrusiveLvl: 0,
debug: false,
smartLoad: true,
startOpened: false,
stayOpen: false,
posHelper: true,
minWidth: 250,
minHeight: 250,
activeChild: ‘emmaactive’,
activeParent: ‘allChildrenEmmaactive’

]);
</script>

The above is an example of how the CCS class of the software can be extended with custom settings. The software is the class constructor and parses in an object as a parameter. The object may contain the above properties but this is not required. It is only required that the object include properties and values that are distinct from the default setting. Omitted properties will inherit the default value which themselves may be subject to change.

Below are the properties and values of the instant object.

publicKey

(type: String)

This is a randomly generated key assigned to every activated website. Before the constructor will continue to load images, it requires authentication against the server with this key. This is the only setting that is required. However, it is not necessary to pass it in with the constructor settings. The key may also be delivered by appending the key onto the end of the JavaScript URL with a hash symbol as described above for Routine 1. One of two routines is mandatory. If both routines are used manually extending the constructor setting will override the URL method.

intrusiveLvl
(type: Integer, default: 0)
possible values: 0, 1, 2

Each value prompts the software to behave differently with user input.

(value=0)

A user must click an icon for a tagging interface to overlay the image. Clicking the icon again will close the tagging interface. This is level one intrusive.

(value=1)

A user must hover a cursor over the image for the tagging interface to overlay the image. Hovering the cursor off the image will close the tagging interface. This is level two intrusive.

(value=2)

A user must hover a cursor over the image for the tagging interface to overlay the image, however this will also load links below the image as well. Hovering the cursor over the links below the image will cause the corresponding tag over the image to highlight. Hovering the cursor off the image will close the tagging interface. This is level three intrusive.

Debug

(type: Boolean, default: false)
possible values: true, false

If debug is set as true, the software will use the browser console to display important information such as error messages, warnings, and a list of each JSONP™ request.

smartLoad

(type: Boolean, default: true)
possible values: true, false

If smart load is set as true, the software will ignore images that are not visible. An event is applied to the browser document that will listen for changes that may indicate an image may now be visible. Each time this event is run, an actual check is performed to see if the image is now visible. If the image is in fact visible, the event is removed and tagging interface will be loaded on the image.

startOpened

(type: Boolean, default: false)
possible values: true, false

If this property is set as true, the software will ignore tagging interface activation events defined by the intrusive level. Instead the software will go ahead and activate the tagging interface when the browser is loaded.

stayOpen

(type: Boolean, default: false)
possible values: true, false

If this property is set as true, the software will ignore tagging interface closure events defined by the intrusive level. Instead the software will make sure the tagging interface remains open at all times, i.e. the tagging interface cannot be closed.

posHelper

(type: Boolean, default: true)
possible values: true, false

If this property is set as true, the software will use computed styles to help position the image wrapping elements on the page. This is essential for elements that are absolutely positioned or centered with margin auto. Setting this property as false may save some runtime and reduce inline styles. This property is preferably only used if necessary.

minWidth

(type: Float, default: 250)

This property determines the pixel value at which an image is determined to be too small horizontally to fit the tagging interface. If the width of the image is smaller than this setting then the image will be ignored.

minHeight

(type: Float, default: 250)

This property determines the pixel value at which an image is determined to be too small vertically to fit the tagging interface. If the height of the image is smaller than this setting then the image will be ignored.

activeChild

(type: String, default: ‘emmaactive’)

This property will determine which class name is used to identify images that require the tagging interface. It is globally used, so any html IMG element in the document with this defined class name will be loaded with the software.

activeParent

(type: String, default: ‘allChildrenEmmaactive’)

This property will determine which class name is used to identify an element that groups images that require the tagging interface. It is globally used, so any element with this defined class name will be iterated over in a search for any html IMG elements that will be loaded with the software. The images do not require the activeChild class name because all children images of the activeParent element will be loaded.

As shown at step 1330 every registered website receives a public key that must be verified with our server each time the constructor is run. If a public key is not provided the software will not run. If a public key is provided the server sends the public key and corresponding web address to a file via JSONP™ for analysis as shown at step 1340. The public key is saved in a database that is linked with the registered account. If the provided key does not match the account key then routine will fail silently. If the key is valid, the server will return a JSONP™ encoded object with custom settings defined by the online account as shown at step 1350. This will function very similar to the custom defined settings demonstrated above. However any settings defined by the constructor parameter will override these server settings.

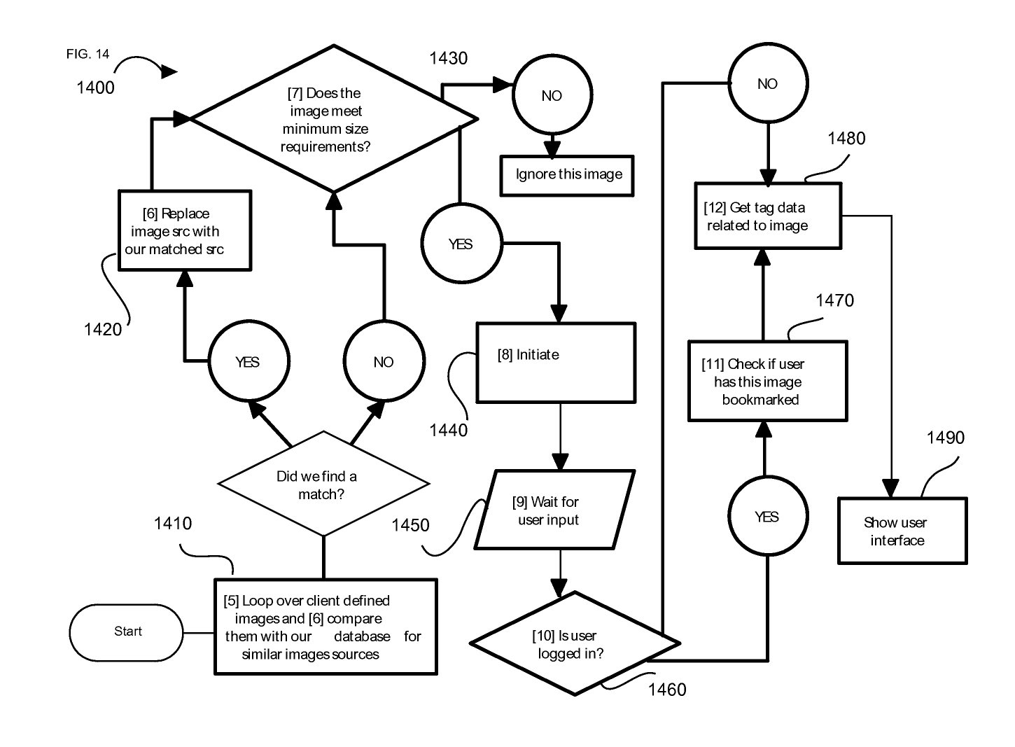

The software will now iterate over the Document Object Model (DOM) and find images to be loaded as shown in the routine 1400 of FIG. 14. At step 1410 images are loaded by the following two routines:

### Routine C

Give each desired image on the website a default class name which may be custom defined in the settings as described above for the constructor settings.

### Routine D

Wrap a group of images in a block level element such as a DIV tag and give it a default class name which may be custom defined in the settings as described for the constructor settings.

Each image loaded by software gets compared with a database of images previously tagged on other websites. This is accomplished by saving Message-Digest algorithm 5 (MD5) hashes of other activated images into a database. Each image produces a unique character string which is easily comparable. The current image is then MD5 hashed on the fly and compared with the database of other hashes. The server will return a matched image source URL if a hash match is found. This new image source is used as a replacement to later load tags as shown at step 1420. This makes it possible to load tags from other websites that have the same image and allows tracking of images across domains so to prevent duplicate tags.

The software will then determine if the image meets minimum size requirements to properly display the tagging interface at step 1430. Images that are too small to properly display the user interface are ignored. The dimensions are typically defaulted to 250×250 pixels but can also be custom defined in the settings as described above for the constructor settings.

Once all restrictions have been met the tagging interface is loaded onto each selected image at step 1440. A temporary image element is created and an event is added to determine when the temporary image element has loaded. The loaded temporary image is given the same source URL as the real image. This may be necessary for cross browser compatibility. It is presumed that the real image has loaded when the temporary image has loaded and the temporary image and event are removed before the DOM modification process begins. The image is wrapped in a DIV wrapper element that will hold other necessary HyperText Markup Language (HTML) elements that construct over the tagging interface. All computed styles are transferred from the image to the wrapper because the wrapper encases the image. The styles of both elements are now compared to determine the differences. Only style properties that are unequal are applied to reduce the amount of inline styles. The image dimensions are hardcoded onto various interface elements to avoid any CSS havoc that may occur. Any unwanted attributes from images such as “align” or “hspace” or “vspace” are removed because these will be mimicked by computed styles and are also deprecated. The interface wrapper is then created and appended beside the image. All button interface elements and tag holders are inserted into this wrapper. An on/off icon, i.e. icon 410 shown in FIG. 4A, is appended beside the interface wrapper so that it remains visible even when the wrapper is hidden. Necessary events are applied to each interface element once inserted into the dome.

Once everything has been loaded and is DOM ready, the system waits for user input to activate the tagging interface at step 1450. The user may activate the tagging interface by clicking an icon on the image, rolling a cursor over the image, or hovering a cursor over a list of tags in a footer of the image.

Every time the user interface is activated a check is performed to determine if the user is logged in via JSONP™ and the server will check on the status of the user session created during the login process as shown at step 1460. A server session is used over a browser cookie for diversity and security reasons. The session remains on the server until the browser is closed. Afterwards, garbage collection will kill the session. The server will return true or false depending on whether the session still exists or not. Once the server responds, the tagging interface will hide or show the login and logout interface buttons as needed. These buttons are located in the interface wrapper.

Every time the user interface is activated and the user is logged in, a check is also performed to determine whether an image has been bookmarked as shown at step 1470. If the image is not bookmarked the tagging interface will allow the image to be bookmarked.

Every time the tagging interface is activated tag data related to the image is received as shown at step 1480. An array of tag identifiers for each image is saved into a cookie and the array is sent via JSONP™ for comparison with a database of tag identifiers associated with the image. If the database contains a contradictory array of tag identifiers, an array of new tag data is sent back. The new array is pre-sorted using an algorithm based on user click patterns and history to determine the order of the tags. The tags at the top of the list are tags the user is most likely to be interested in. The tag holder element is then erased and repopulated with this new array of tag data from the server. The identifier from each tag is taken to update the image's cookie tag array. This saves bandwidth and runtime when future checks for new tags are performed. The tagging interface and tags are then displayed as shown at step 1490. In one embodiment an image may only have ten tags visible at any given time. The visible tag dots may be chosen based on payment amount, available advertising credit, how much more of the advertisers monthly budget remains and date of creation.

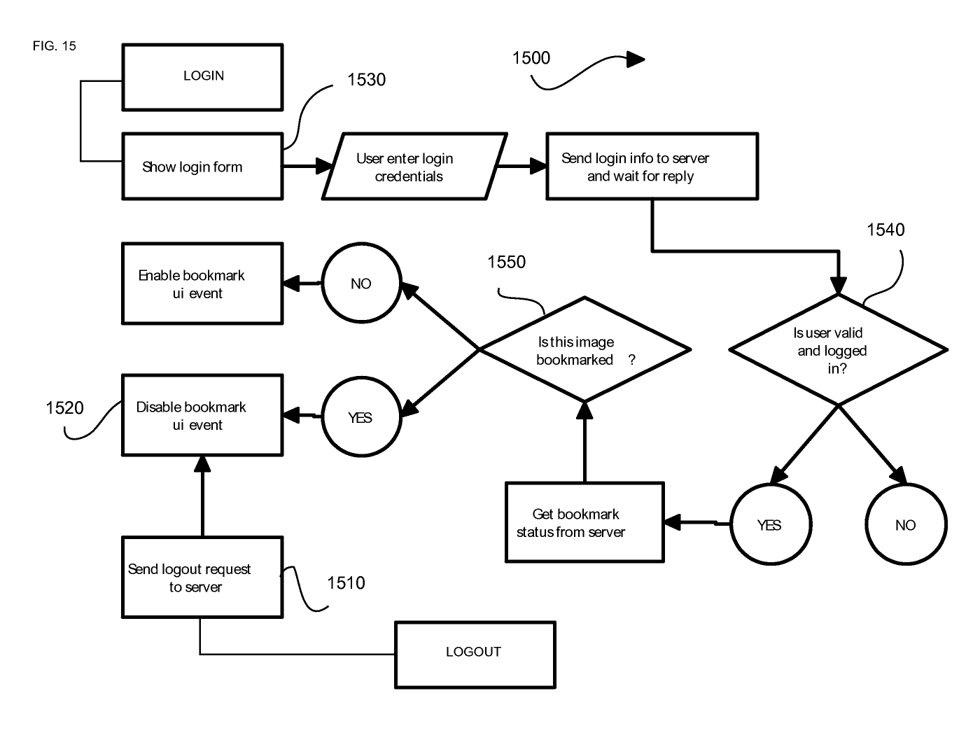

FIG. 15 shows a routine 1500 for a user to login and logout of the system. To logout of the system a session destroy request is sent to the server at step 1510. The session ID is erased from the database on the server and the session itself is killed. Once this is completed any bookmarked data is cleared from the interface at step 1520.

To login to the system a login form is displayed at step 1530. When the user submits the form, the password is SHA1 encrypted, and sent along with the username to the server. The password and username are then compared with the database records for a match at step 1540. If a match is found, the provided password and username are considered valid and the server creates a new user session by updating the user's account record with a randomly generated Universally Unique Identifier (UUID). The UUID is used as the session variable content. The session will automatically die if the browser is closed or the user manually logs out. The session and its content are later used to query the account records so that user info can be retrieved from the database including logged on/off status. The server sends back a response declaring the status of the session. The user interface is then updated accordingly. In particular, the server will check to determine whether an image has been bookmarked as shown at step 1550. If the image is not bookmarked the tagging interface will allow the image to be bookmarked at step 1560.

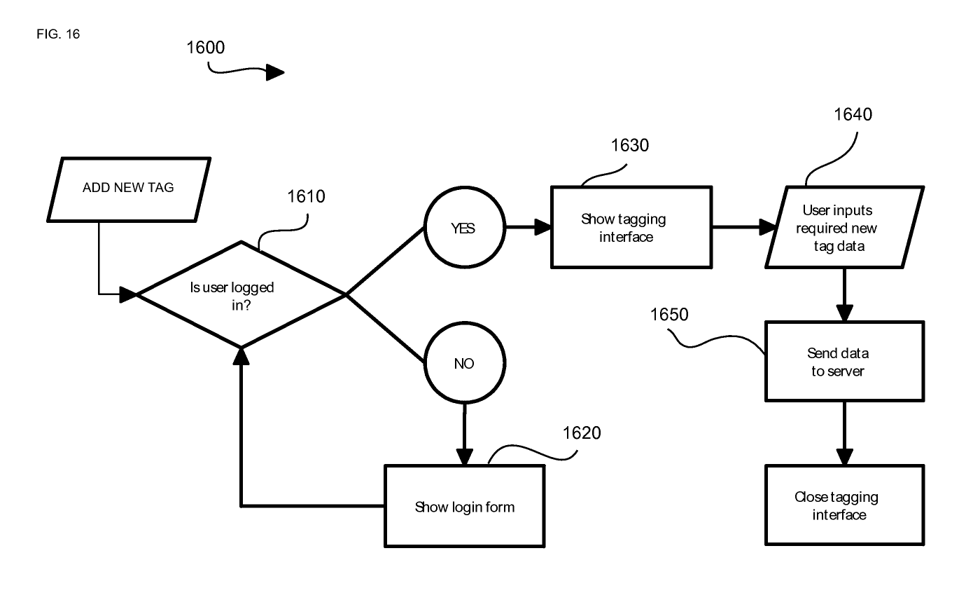

FIG. 16 shows a routine 1600 for placing a new tag. Before a new tag can be placed a check is performed at step 1610 to determine if the user is logged in. If the user is not logged in they are prompted to do so at step 1620. In this example, the user must be confirmed as logged in before the tagging interface is displayed, at step 1630, and a tag can be placed. The user is then prompted to click on the image where the tag will be placed. After a selection is made, a form is presented that asks for data related to the tag such as a tag name, destination URL, and keywords as shown at step 1640. The tag name input field may use a suggestion dropdown list to display similar tags related to what the user is typing. Each key press sends a query which contains the current tag name as it is being typed. The server may analyze what the user is typing and responds with an array of similar tags. This array is JSON encoded and passed to JavaScript® where it is converted into a dropdown list. The click position is converted from pixels into percentage values and saved into hidden fields. This permits the image to change size provided the aspect ratio remains the same. When the form is submitted, the form data and click position are sent to the server via JSONP™ as shown at step 1650.

The data is validated and stored in a database. The user is then notified via email that a tag has recently been placed on an image located on their website. The email contains a link to the user's online account page, where the recently placed tag may be viewed. If the user requires that each tag be manually approved, the linked page will also ask for approval. Alternatively, a user can have each tag auto-approved without their intervention using two methods. The first method approves every incoming tag. The second method further analyzes a tag trustworthy score of the user who placed the tag and determines if said user is trustworthy enough to tag. The tag trustworthy score is based on a user's tag history. The system tracks the number of tags a user has had accepted/denied/reported and the number of websites that have banned the user from tagging altogether. Based on a user's tag trustworthy score, a placed tag may be auto-denied, auto-approved, or held pending the approval of the website owner. If approved, the tag becomes fully functional. If rejected, the tag is removed.

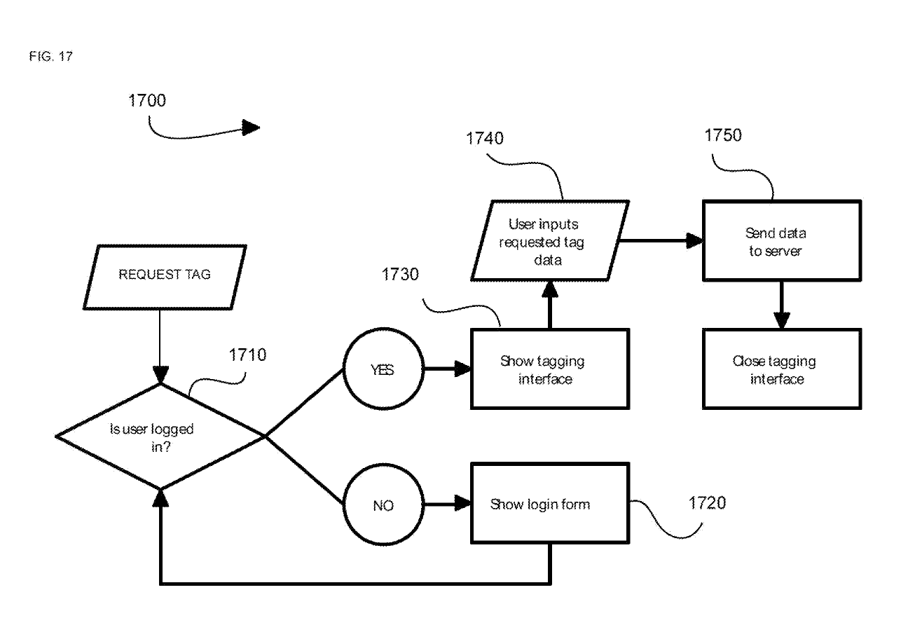

FIG. 17 shows a routine 1700 for requesting a tag. Before a user can request a tag a check is performed at step 1710 to determine if the user is logged in. If the user is not logged in they are prompted to do so at step 1720. In this example, the user must be confirmed as logged in before the tagging interface is displayed, at step 1730, and a tag can be requested. The user is asked to click on the image where the tag will be displayed. After a selection is made, a form is presented at step 1740 which requests data related to the requested tag such as a tag name and keywords. The click position is converted from pixels into percentage values and saved into hidden fields. This permits the image to change size provided the aspect ratio remains the same. When the form is submitted, the form data and click position are sent to file via JSONP™ as shown at step 1750. The data is validated and stored into a database. The requested tag is immediately shown alongside real tags but appears differently from regular tags, the same approval process as for regular tags happens, and when clicked on the requested tag prompts other users to enter the requested information. The prompt is exactly the same as that for creating a new tag, but without having to choose a click position. When the request is fulfilled by a user providing the proper tag information, a validation process is performed which is the same as that for newly created tags.

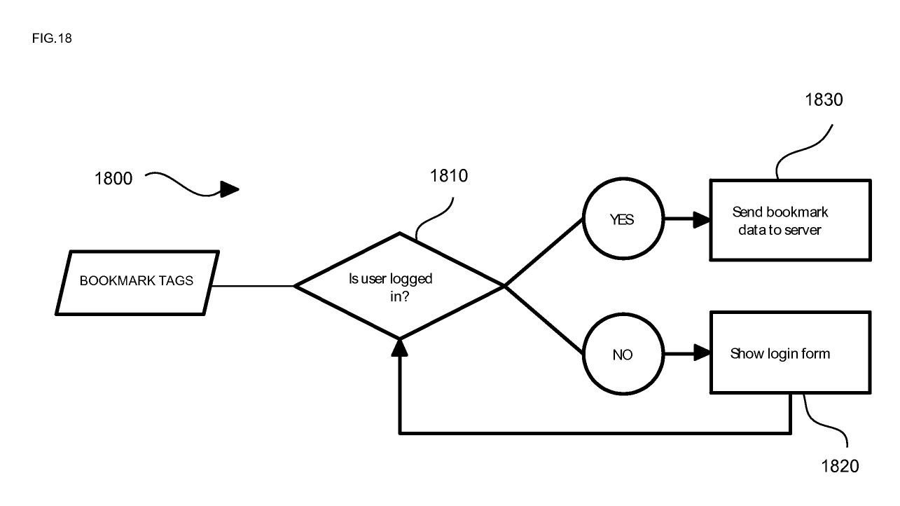

FIG. 18 shows a routine 1800 for bookmarking a tag. Before a user can request a tag, a check is performed at step 1810 to determine if the user is logged in. If the user is not logged in they are prompted to do so at step 1820. In this example, the user must be confirmed as logged in before a tag can be bookmarked. Bookmark data is sent to the server at step 1830 where it is stored. An image may only be bookmarked once, and the interface is updated to visually confirm that the image has been bookmarked.

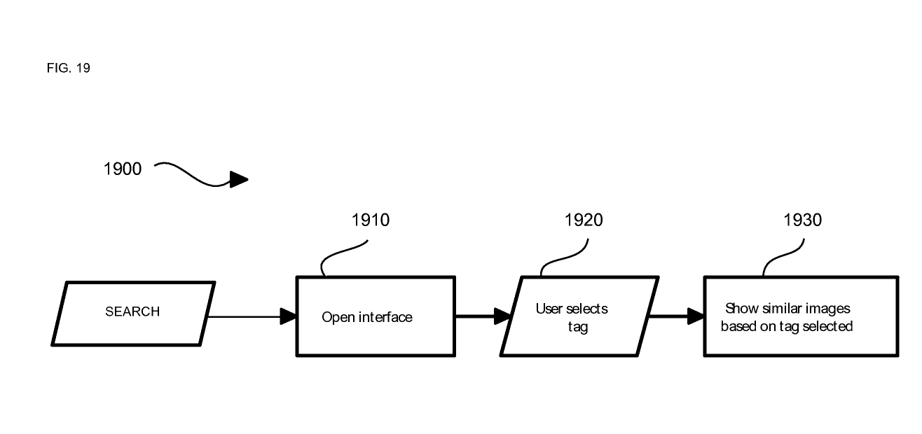

FIG. 19 shows a routine 1900 for searching for similar images. A user activates the tagging interface at step 1910 and selects a tag 1920 at step 1920. To search for images similar to the selected tag, the selected tag is relocated to the server where the selected tag identifier is used to grab keywords from a database. Using the keywords a search is performed for images containing similar keywords. The images are displayed to the user at step 1930.

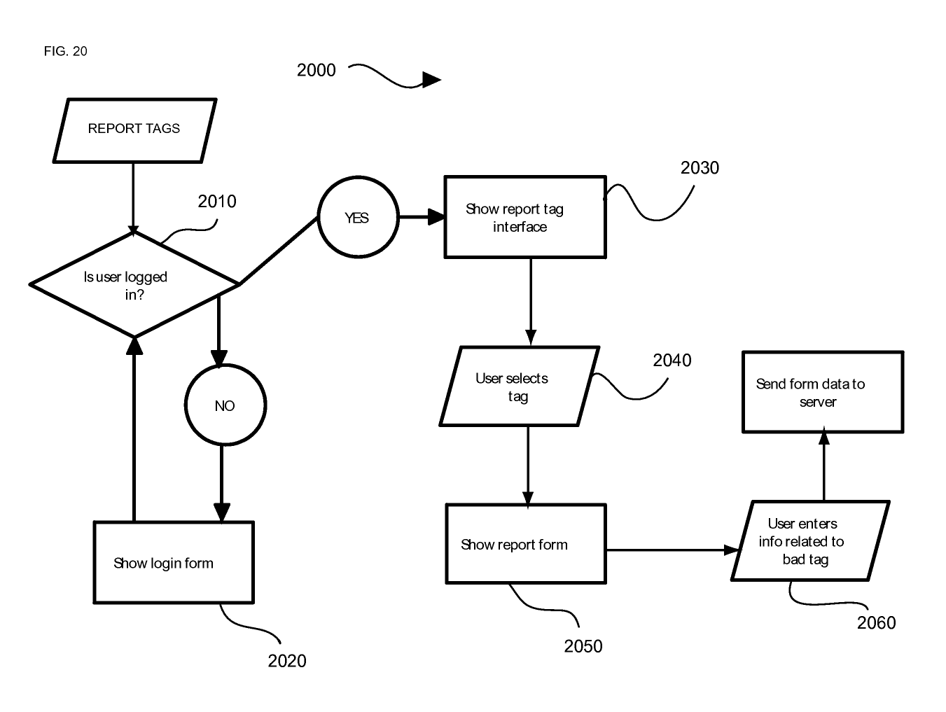

FIG. 20 shows a routine for reporting tags 200. Before a user can report a tag a check is performed at step 2010 to determine if the user is logged in. If the user is not logged in they are prompted to do so at step 2020. In this example, the user must be confirmed as logged in before the tagging interface is displayed, at step 2030, and a tag can be reported. The user selects a tag to be reported at step 2040. A report form is presented at step 2050 after a tag is selected for reporting. The user inputs information on why the tag is being reported into the report form at step 2060. The report form may include a dropdown list of reasons for reporting a tag and an input field to enter further comments. The owner of the website on which the tag is placed is notified by email so a decision can be made as to the removal of the reported tag.

It will be understood by a person skilled in the art that many of the details provided above are by way of example only, and are not intended to limit the scope of the invention which is to be determined with reference to the following claims.

What is claimed is:

1. A method for tagging of an image on a website, the method comprising:
embedding a code into a template file of a website;
executing the code to activate the image by overlaying a tagging interface on the image; and
placing a tag within the image and storing a copy of the tag in a database supported by a remote server, wherein a unique random string of characters is generated as a function name before data is posted to the remote server and executes a string function which reduces a potential of an injected function to allow the tag to be displayed on the website and the copy of the tag be posted to the remote server while maintaining system security.

2. The method as claimed in claim 1 further including determining a level of intrusiveness of the tagging interface.

3. The method as claimed in claim 2 wherein placing the tag within the image in a first level of intrusiveness includes clicking an icon on the image.

4. The method as claimed in claim 2 wherein placing the tag within the image in a second level of intrusiveness includes rolling a cursor over the image.

5. The method as claimed in claim 2 wherein placing the tag within the image in a third level of intrusiveness includes hovering a cursor over a list of tags inside the image.

6. The method as claimed in claim 2 wherein determining the level of intrusiveness of the tagging interface includes toggling the level of intrusiveness.

7. A method for tagging of an image on a website, the method comprising:
embedding a code into a template file of a website;
executing the code to activate the image by overlaying a tagging interface on the image;
providing a means to allow a first user to place a tag request on the image to request additional information on the image; and
providing a means to allow a second user to respond to the tag request by placing a tag within the image and storing a copy of the tag in a database supported by a remote server, wherein a unique random string of characters is generated as a function name before data is posted to the remote server and executes a string function which reduces a potential of an injected function to allow the tag to be displayed on the website and the copy of the tag be posted to the remote server while maintaining system security.

8. The method as claimed in claim 7 wherein providing the means to allow the first user to place the tag request further includes providing a database to store the tag request.

9. The method as claimed in claim 8 wherein providing the means to allow the second user to respond to the tag request includes allowing the second user to search the database.

10. The method as claimed in claim 7 wherein providing the means to allow the second user to respond to the tag requests includes allowing the second user to provide the first user with a reward for placing the tag.

11. A method for tagging of an image on a website, the method comprising:
embedding a code into a template file of a website;
executing the code to activate the image by overlaying a tagging interface on the image;
placing a tag within the image and storing a copy of the tag in a database supported by a remote server, wherein a unique random string of characters is generated as a function name before data is posted to the remote server and executes a string function which reduces a potential of an injected function to allow the tag to be displayed on the website and the copy of the tag be posted to the remote server while maintaining system security; and
providing a means for a first user and a second user to bid on the tag with the image, and linking the tag to a website of a highest bidder of the first user and the second user.

12. The method as claimed in claim 11 wherein providing the means for the first user and the second user to bid on the tag includes allowing each of the first user and the second user to bid an amount to be paid for each click on the tag and bid a total amount to be paid, and wherein linking the tag to the website of the highest bidder includes linking the tag to the website of either the first user or the second user who bids a higher amount to be paid for each click on the tag until the total amount to be paid by said user first user or second user is reached.

13. The method as claimed in claim 11 further including paying a third user a royalty for placing the tag.

14. The method as claimed in claim 11 further including paying a third user a royalty for placing the tag wherein the royalty is a percentage of a bid placed by the first user or the second user.
